(19) United States
(12) Patent Application Publication
(10) Pub. No.: US 2025/0172244 A1
(43) Pub. Date: May 29, 2025

(54) SYSTEM AND OPERATING METHOD FOR ENHANCED DORMANCY IN CRYO-COMPRESSED HYDROGEN STORAGE VESSELS

(71) Applicant: Verne Inc., San Francisco, CA (US)

(72) Inventors: David E. Jaramillo, San Francisco, CA (US); Julio Moreno-Blanco, San Francisco, CA (US); Salvador Aceves, Salamanca (MX)

(73) Assignee: Verne Inc., San Francisco, CA (US)

(21) Appl. No.: 18/842,615

(22) PCT Filed: Mar. 26, 2023
(86) PCT No.: PCT/US2023/064970

§ 371 Date: Aug. 29, 2024

Related U.S. Application Data
(60) Provisional application No. 63/323,896, filed on Mar. 25, 2022.

(51) Int. Cl. F17C 1/00

(52) U.S. Cl. CPC F17C 1/00; F17C 2203/0604; F17C 2221/012; F17C 2223/0161

(57) ABSTRACT

A system and method for operation for cryo-compressed hydrogen storage can include: an inner pressure vessel that includes an inner liner with a defined inner volume configured for para to ortho conversion of gaseous hydrogen before venting; an insulation layer, situated outside the inner pressure vessel; an outer wall; and a support structure situated between the inner pressure vessel and the outer wall.

### CROSS-REFERENCE TO RELATED APPLICATIONS

This Application claims the benefit of U.S. Provisional Application No. 63/323,896, filed on 25 Mar. 2022 which is incorporated in its entirety by this reference.

### TECHNICAL FIELD

This invention relates generally to the field of cryo-compressed hydrogen storage, and more specifically to a new and useful system and method for enhanced dormancy in cryo-compressed hydrogen vessels.

### BACKGROUND

Cryo-compressed hydrogen (CcH₂) storage is a combination of the attributes of compressed gaseous hydrogen (GH₂) storage and liquid hydrogen (LH₂) storage. One of the disadvantages of compressed hydrogen storage technology is that large volumes and high pressures are required to store sufficient energy for desired applications. Some of the main disadvantages of liquid hydrogen storage are boil-off losses, high operational complexity, high-costs, and a centralized supply chain. Cryo-compressed hydrogen storage serves to address some of these challenges to enable a solution that combines the availability and usability of GH₂ with the high densities of LH₂.

A disadvantage of current cryogenic hydrogen storage solutions is the boil-off or venting losses. That is, as cryogenic hydrogen naturally warms up, the pressure in storage vessels may naturally increase. As the pressure reaches the limits of the storage vessel, hydrogen must be vented to reduce the internal pressure of the storage vessel, thus wasting the stored resource.

As cryo-compressed hydrogen storage has started to advance from the laboratory scale to market entry, there is a greater need to extend the duration (i.e., dormancy or time before a venting event) of this storage to enable even further utility of hydrogen as an energy source (e.g., fuel). Though current technology has made great gains in hydrogen storage, the inevitable boil-off or blow-off loss, that requires venting of hydrogen, and thus loss of hydrogen, that arises from heat leak into the system, is still a significant issue.

Thus, there is a need in the field of cryo-compressed hydrogen storage to increase the dormancy and thereby reduce, or remove, the need to vent and waste hydrogen. This system and method provide such a solution.

### BRIEF DESCRIPTION OF THE FIGURES

FIG. 1 a schematic overview of an example storage vessel.

FIG. 2 is a detailed schematic of an example storage vessel with an exemplary cross-sectional view of a portion of the storage vessel.

FIG. 3 is an image of an example system comprising a set of storage vessels integrated into a vehicle.

FIG. 4 is a schematic for an example set of storage vessels system implemented on a truck.

FIG. 5 is a plot of hydrogen dormancy for simulated storage vessel volume to surface area ratios.

FIG. 6 is a comparative plot of the volume to surface area ratio for different storage vessels geometries with identical storage volume.

FIG. 7 is a schematic for an example system that is relatively cylindrical with isotensoid shaped ends.

FIG. 8 is a schematic of an example system comprising a set of storage vessels that are relatively cylindrical with isotensoid shaped ends.

FIG. 9 is a schematic of an example system comprising a set of storage vessels that are relatively spherical.

FIG. 10 is a graph demonstrating the effect of volume-to-surface area (V/SA) on dormancy, for a fixed volume of hydrogen, assuming a venting pressure of 400 bar. FIG. 11-15 are schematics of example systems that includes a catalyzing system.

FIG. 16 is a graph demonstrating the benefits of optimizing the catalyst rate to extend dormancy.

FIG. 17 is a graph demonstrating the effect of a para to ortho conversion catalyst on hydrogen pressure in the tank.

FIG. 18 is a graph demonstrating the effect of catalyst activation, multiple times, on the hydrogen pressure and on dormancy.

FIGS. 19 and 20 are flowcharts of variations of methods of operating a cryo-compressed storage system.

FIG. 21 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and operating method for a cryo-compressed hydrogen storage functions to use custom configuration of the storage system to leverage a para-to-ortho conversion of cryo-compressed gaseous hydrogen. The system and operating method may involve use of a storage vessel for cryo-compressed hydrogen that includes an inner pressure vessel, with a geometry that configured for para to ortho conversion of hydrogen molecules under relevant time scales; an insulation layer; and an outer wall. In many variations, the system may comprise a plurality of these storage vessels that can be managed in a coordinated fashion to offer increased hydrogen fuel storage.

The operating method, for utilization-based storage of cryo-compressed hydrogen, comprises: storing cryo-compressed hydrogen in the storage vessel; dispensing cryo-compressed hydrogen from the storage vessel; at a threshold pressure below the venting pressure of the storage vessel, inducing a para to ortho conversion of hydrogen, thereby reducing the internal pressure within the storage vessel; and at the venting pressure, venting the cryo-compressed hydrogen within the storage vessel. Various approaches may be used in the management of the para to ortho conversion to adjust the dormancy and/or venting of stored hydrogen.

The system and method function to provide a utilization-based means of storing cryo-compressed hydrogen. That is, the system and method provide an efficient means of cryo-compressed hydrogen storage, that depends on the frequency and amount of cryo-compressed hydrogen that is utilized, that reduces the amount of venting necessary to maintain the system. operate a hydrogen storage system that enables extended storage of hydrogen with a reduced need to vent hydrogen.

In many variations, the system and method may include a plurality of storage vessels for operation and storage. The plurality of storage vessels may be interconnected and have a control mechanism, enabling controlled gas exchange between the storage vessels, i.e., transferring cryo-compressed hydrogen between storage vessels.

The system and operating methods described herein leverage novel and surprising approach to leverage endothermic reaction resulting from conversion between para and ortho states of Hydrogen molecules (H₂). For cryo-compressed hydrogen, the nuclear spin state of hydrogen may be leveraged for thermal management. Hydrogen molecules (H₂), have two nuclear spin states: an ortho configuration and a para configuration. The para configuration is the thermodynamically favored state but at room temperature, hydrogen molecules populate both states; and bulk hydrogen comprises approximately 75% ortho- and 25% para-H₂. This is known as “normal” hydrogen. As hydrogen is cooled, the para-H₂ population increases, reaching 99.7% at 20 K and 1 bar. Conversion of ortho hydrogen to para hydrogen is a very exothermic reaction. At 20 K, 708 KJ/kg is released during the conversion, which is greater than the enthalpy of vaporization of hydrogen (445 kJ/kg). As a result, to avoid substantial boil-off losses during liquefaction, this conversion is used. This reaction may use a catalyst, to accelerate the conversion. Once hydrogen has reached its equilibrium concentration at cryogenic temperatures, and the system is subsequently warmed up, para-to-ortho conversion is possible. This is an endothermic reaction which can effectively absorb heat flux and thereby extend time before a venting event occurs (i.e., increase hydrogen “dormancy”).

The system and method may be implemented in any general use case of cryo-compressed hydrogen storage and./or utilization. The system and method may be particularly useful for use cases where there may be long unexpected dwell times, such as in delivery trucks, or in light-duty vehicles. The system and method of operation may have applications to enabling hydrogen fuel storage for vehicles such as trucks, trains, aircrafts, boats, construction vehicles, and/or other types of vehicles. The system and method of operation may also be used for fuel storage solutions for powering other types of systems such as data centers, facility power generation, and the like. The system and method of operation may additionally or alternatively be used in refueling stations or other fuel storage facilities. The system and method of operation is not limited to these areas of application, and they be applied to a variety of applications for storage of hydrogen fuel.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

One potential benefit of the system and method is to provide a generally less wasteful use of cryo-compressed hydrogen. As current systems of cryogenic hydrogen require venting, in particular at high tank capacity filled rates (e.g., 100% filled), this system and method provide a potential means to prevent and/or reduce hydrogen venting across all tank capacity rates.

With the potential benefit of reduced hydrogen venting, the system and method may provide the related benefit of hydrogen being a more useful alternative fuel source with a reduced cost.

Another potential benefit of the system and method is providing a more reliable system for operation of hydrogen fuel vehicles. An improvement in dormancy, even at 100% fill, may give operators and individual drivers more confidence that hydrogen-operated vehicles can meet route demand even under unexpected circumstances.

Additionally, extended dormancy provides more flexibility for refueling times and route planning, which is a critical factor in large delivery truck fleet operators. Furthermore, extended dormancy means less wasted hydrogen and a lower total cost of ownership.

The system and method potentially provides the benefit of improved storage efficiency of hydrogen. By leveraging storage vessels that have design features like defined internal volumes with volume to surface area geometries within a para-to-ortho optimized range, the system and method may provide improved dormancy. In some variations, this improved dormancy may be four times better dormancy for hydrogen storage as compared to current liquid hydrogen storage.

Additionally, the system and method may provide the potential benefit of a tuned dormancy for specific applications by modifying the volume to surface area ratio, of the storage vessel.

With the efficient use of para to ortho conversion of hydrogen the system and method provides the additional potential benefit of a storage system that exhibits a negative apparent heat transfer.

Another potential benefit is that the system and method does not require the hydrogen fuel to have a specific ortho hydrogen percentage. It some cases, the hydrogen fuel entering the tank may have a concentration that is different than that of typical liquid hydrogen (>99% para). For example, the hydrogen fuel may be prepared from a cryo-compressing process, such as that described by U.S. Provisional Patent 63/427,814. Such a fuel will have para concentrations that can vary from 25% para to 50-60% para.

### 2. System

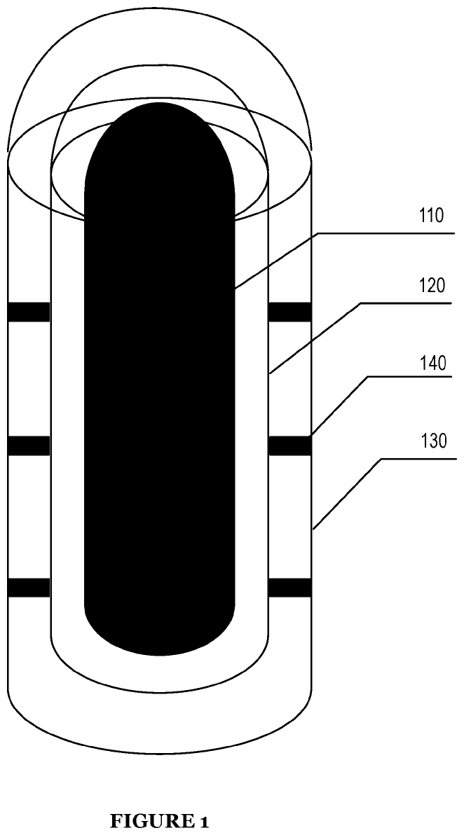

As shown in FIG. 1, a system for cryo-compressed hydrogen storage, may include an inner pressure vessel 110 that includes an inner liner 3 with a defined inner geometry. that enables para to ortho conversion of gaseous hydrogen before venting. More specifically, the defined inner geometry of the inner liner is configured for para to ortho conversion of gaseous hydrogen; where in most variations, this comprises an internal, volume to surface area, ratio within a para-to-ortho optimized range as described herein. The system may also include an insulation layer 120, situated outside the inner pressure vessel 110; an outer wall 130; and a support structure situated between the inner pressure vessel 110 and the outer wall 130.

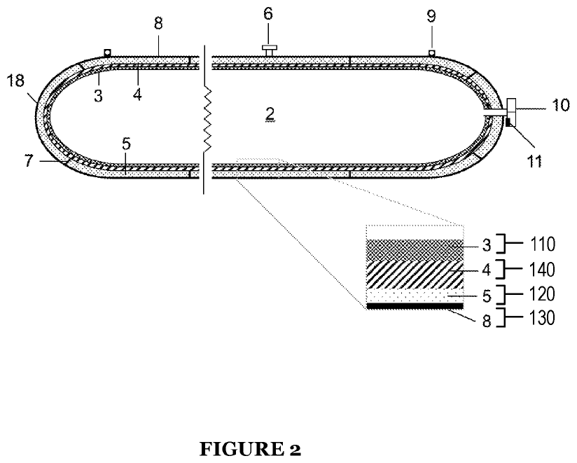

As shown in the detailed variation of FIG. 2, the system may more particularly include: an inner pressure vessel 110, comprising: an inner liner 3 with a geometry that enables para to ortho conversion of the hydrogen molecules under relevant time scales (i.e. before venting); an insulation layer 120 comprising insulating material 5; an outer wall 130, comprising an outer jacket 8, and a support system 140, comprising a composite overwrap 4 situated outside the inner liner 3, and a support structure 7 situated between the composite overwrap 4 and the outer wall 130.

When integrated into an exemplary implementation such as that shown in FIG. 2, the system for a cryo-compressed hydrogen storage vessel may include or be used with a system that includes a defined storage volume 2, an inner liner 3 (e.g., made of stainless steel or aluminum), a composite overwrap 4 made potentially made of carbon fiber, and epoxy; an insulation layer 5; and an outer jacket (e.g., made of stainless steel or aluminum). The exemplary implementation may include an optional vacuum valve 6, support structures 7 (e.g., G10 or other materials), optional hooks or other handling structures 6 (e.g., used for moving, attaching, or other handling functionality), a valve 10, and possibly a solenoid 11.

The system functions as an enhanced dormancy storage vessel for cryo-compressed hydrogen. More specifically, the system functions as a storage vessel for cryo-compressed hydrogen (i.e., low temperature, moderate pressure), that helps induce, and/or control, the conversion of hydrogen molecules in a para state to an ortho state (also referred to as para to ortho conversion, para to ortho hydrogen conversion, or para-ortho conversion). The system, as a cryo-compressed hydrogen storage vessel, may further enable both mobile and stationary storage for direct use of hydrogen (e.g., as a fuel source for running vehicles). Additionally, in many use cases the system may further function as a means for cryo-compressed hydrogen storage and implementation (e.g., as fuel cannisters for a truck, ship, data-center, or other machinery that can hydrogen as a fuel source). The cryo-compressed hydrogen storage system may operate under a wide range of pressures and temperatures, including 30 K-300 K, and 5 bar-700 bar, for example. In one embodiment, under normal operations, the system can operate from 30-100 K and 8 bar-400 bar.

The para to ortho conversion of hydrogen is an endothermic reaction. Cryo-compressed hydrogen may warm up over time due to controlled or uncontrolled heat flux through the system, which drives the equilibrium concentration towards ortho-hydrogen. Over time, this results in the endothermic para-to-ortho conversion, which absorbs energy and can thereby increase hydrogen dormancy. In many variations, the system may leverage this para-to-ortho conversion of hydrogen to enhance hydrogen dormancy and thereby reduce the need for hydrogen venting. Thus, in many variations, the system may further include additional components (e.g., a catalyst), and design features (e.g., distinct volume to surface area ratios) to modify the time of dormancy.

As necessitated by implementation, the system may further include components, such as valves, tubing, seals, supports, sensors, and the like. As a system that may leverage the para to ortho conversion of hydrogen to improve hydrogen dormancy, in many variations, the system may further include a catalyst, wherein the catalyst improves the para to ortho conversion rate of hydrogen. In variations wherein the system enables storage and utilization of cryo-compressed hydrogen, the system may further include a dispenser to enable “fueling” from the system.

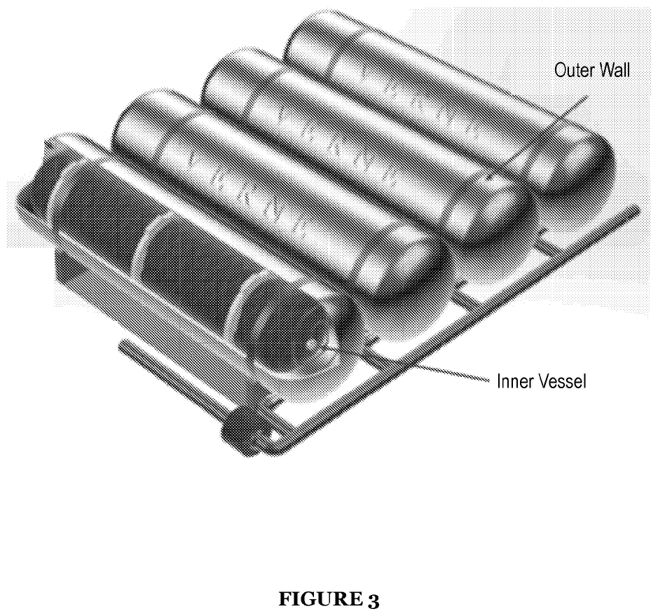

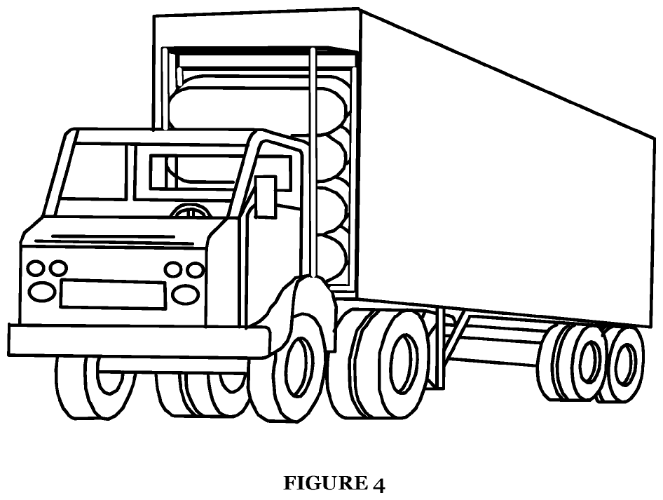

In some variations, as shown in FIG. 3, the system may comprise a set of storage vessels, wherein a subset of the set of storage vessels includes a set of cryo-compression tanks each comprising: an inner pressure vessel 110, an insulation layer 120, an outer wall 130, and a support system 140, as described above; and potential insert components. The set of storage vessels may be a particularly useful for implementations that require hydrogen storage and utilization (e.g., truck or plane operation). The system, comprising the set of storage vessels may further comprise other storage vessels for additional, or other functionality; for example: a storage vessel that stores primarily ortho hydrogen storage, a storage vessel that maintained at ambient temperature, a storage vessel that contains a catalyst for para to ortho conversion, etc. The set of storage vessel variations may function to enable greater amounts of hydrogen storage and potentially provide more streamlined accessibility and storage capability.

In some variations, the set of storage vessels may be substantially similar in design. The storage vessels may be operated in a coordinated fashion. For example, they may be interconnected and controlled for para-to-ortho conversion with similar timing. In another variation, they may be controlled for staggered timing of para-to-ortho conversion. In an alternative variation, the set of storage vessels may include subsets of storage vessels with design parameters for different hydrogen storage characteristics. For example, two different types of storage vessels may be used within the system with a first subset having vessel geometry configured for one dormancy period and a second subset having a vessel geometry configured for a second dormancy period.

The set of storage vessels may be interconnected and have a control system, enabling controlled gas exchange between the storage vessels, i.e., transferring cryo-compressed hydrogen, and other compounds, between storage vessels. Additionally, the system may include an input valve enabling cryo-compressed hydrogen to be pumped into the storage vessel(s); and an output valve enabling cryo-compressed hydrogen to be dispensed for use or venting.

In one example, as shown in FIG. 4, the set of storage vessels may be as a fuel source for a hydrogen fueled truck, wherein each storage vessel is interconnected. Dependent on implementation, the number of storage vessels may vary (e.g., 2 tanks, 3 tanks 4 tanks, etc.) and the relative positioning of the tanks may vary (e.g., linearly aligned storage vessel, 2×2 “square” positioning, 2×4 positioning of storage vessels as shown in FIG. 4, etc.). In this example, the set of storage vessels may include an easily accessible inlet, for easy refueling, and an outlet connected to the truck motor.

As discussed, the system may include an inner pressure vessel 110, which may function as the storage container with a defined cavity that directly contains/stores the cryo-compressed hydrogen. Alternatively, the inner pressure vessel may contain/store other liquids, gasses, and/or contain/store other forms of hydrogen (e.g., hydrogen gas, hydrogen liquid). The inner pressure vessel 110 may comprise an inner liner 3 and a composite overwrap 4. The inner pressure vessel is preferably constructed of material that inhibits hydrogen permeation.

As mentioned, the inner pressure vessel 110 may include an inner liner 3. The inner liner 3 may primarily function to prevent hydrogen from permeating through. Thus, the inner liner 3 may be constructed of material that is inert to hydrogen and limits the permeation of cryo-compressed hydrogen. Additionally or alternatively, the composition of the inner liner 3 may inhibit permeation or may be impermeable to hydrogen gas and/or other compounds that may be placed in the storage vessel. In some variations, the inner liner 3 is composed of aluminum or stainless-steel alloys. Alternatively, the inner liner 3 may be composed of other compounds unreactive and impermeable to hydrogen.

The inner pressure vessel 110 may have a geometry that promotes para-to-ortho conversion of cryo-compressed hydrogen. In many variations, this means that the inner pressure vessel 110 has a volume to surface area ratio that helps enable para to ortho conversion before venting occurs. In particular, the inner pressure vessel 110 includes an inner liner or other structure with a defined internal volume (or cavity) in which the hydrogen is stored. The defined volume can have. Volume to surface area ratio within a para-to-ortho optimized range, which as discovered and outlined herein, for some variations may be greater than 0.7 m (e.g., between 0.7 and 0.11).

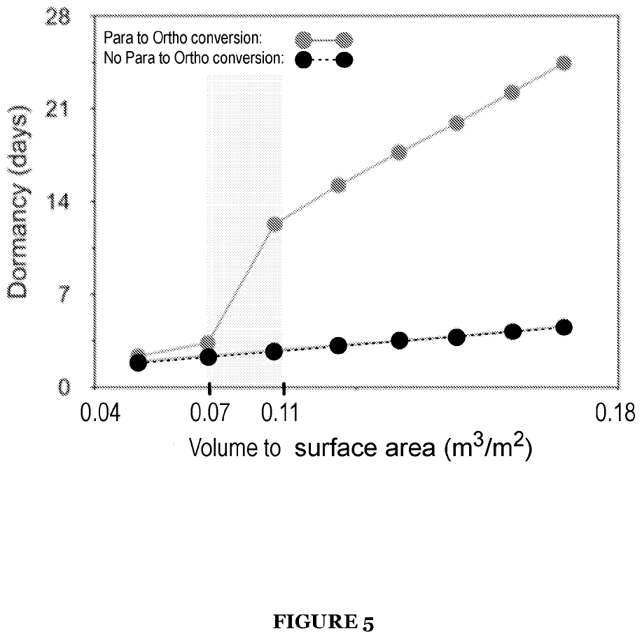

In some examples, the inner pressure vessel 110 is cylindrical with hemi-spherical caps, nearly hemi-spherical caps, ellipsoidal caps or otherwise domed caps. As shown in FIG. 5, different volume to surface area ratios used with para-to-ortho conversion can have a significant impact on dormancy compared to select volume to surface ratios and variations not using para-to-ortho conversions. The system may use select configured volume to surface areas for the inner pressure vessel to have an outsized impact on hydrogen dormancy as the volume to surface area ratio increases between the ratios ˜0.07 m and ˜0.11 m (the shaded grey region), whereas greater than 0.11 m, the hydrogen dormancy may not change as dramatically, but may be used. For example, a volume to surface area change from 0.07 m to 0.11 m (57% increase) improves dormancy from approximately 3 days to 15 days (4.5× increase). In preferred variations, the volume to surface area ratio of the inner pressure vessel 110 may be at least approximately 0.07 m. More preferably, the volume to surface area ratio of the inner pressure vessel 110 is 0.11 m or greater; corresponding to the region to the right-hand side of the shaded region. With regards to improving para to ortho conversion, one variation for optimizing volume to surface area ratio would be an inner vessel with inner pressure vessel 110 defining an internal spherical cavity.

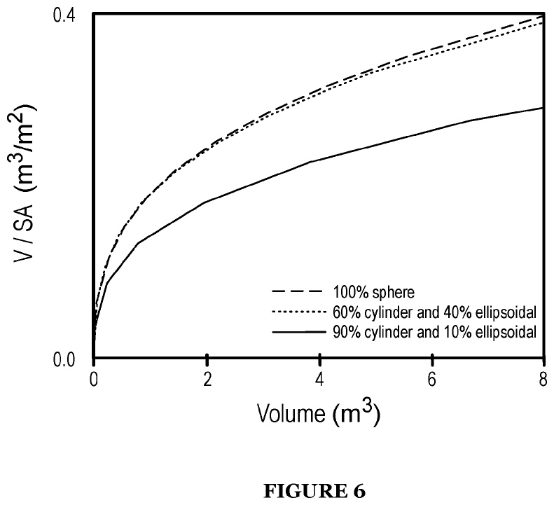

In some applications, alternative shapes may be used to adjust for different requirements for cryo-compressed hydrogen (e.g., moderate pressure, fitting within defined spaces, compatibility with existing infrastructure, manufacturability, etc.). Furthermore, for a given storage volume (e.g., hydrogen storage capacity), a minor increase in the spherical character of the inner pressure vessel 110 may have an outsized impact on dormancy. In other words, a purely spherical storage vessel is not always necessary to achieve a desired length of dormancy. Additionally, as shown in the data in FIG. 6, for a given storage volume, a storage vessel that has 60% of its length as a cylinder, and the remaining 40% of its length defined by ellipsoidal or domed endcaps will exhibit volume to surface area ratios that are more similar to a perfect sphere than to a storage vessel that is more elongated and thus contains more cylindrical character and the same volume (e.g., 90% cylindrical and 10% ellipsoidal). Thus, the volume to surface area ratio of the inner pressure vessel 110 may, in some variations, be anywhere in the shaded region or to the right-hand side of the shaded region of FIG. 5, dependent on implementation. This value corresponds to 0.11, for the system shown in FIG. 5, and can be achieved at different volumes depending on the exact vessel geometry. Thus generally, the volume to surface ratio, is preferably to the right of the shaded region for the system of implementation. Inner presser vessel constituents, e.g., the inner liner 3 may also have a geometry that helps assist para to ortho conversion.

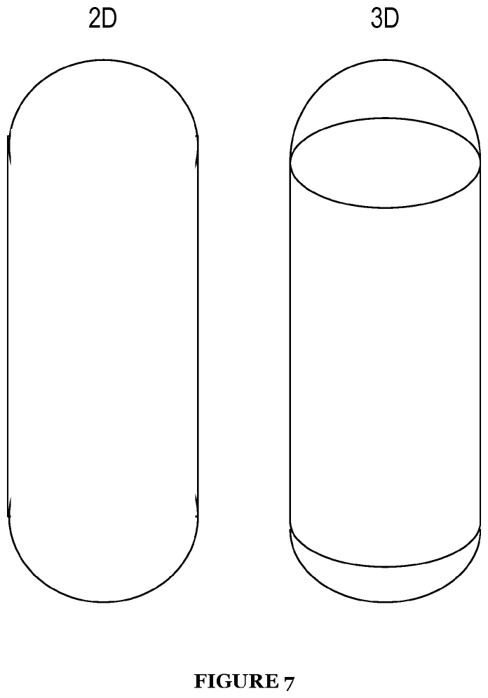

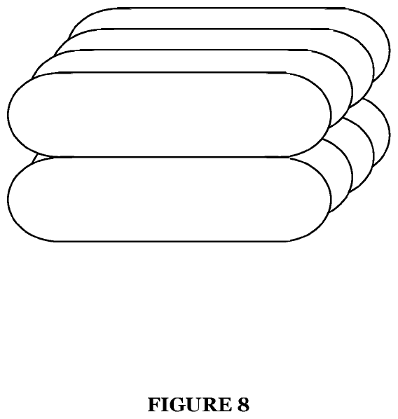

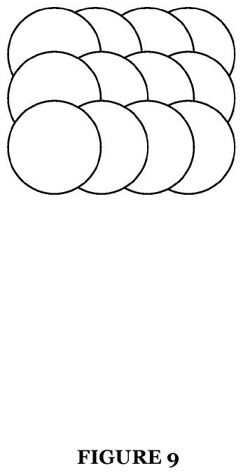

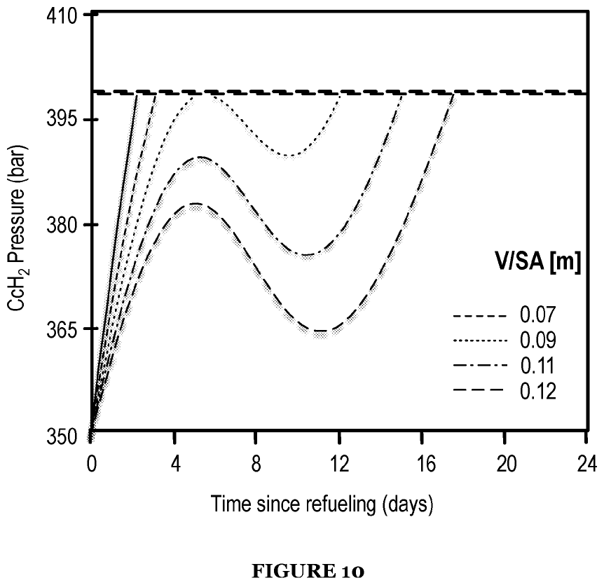

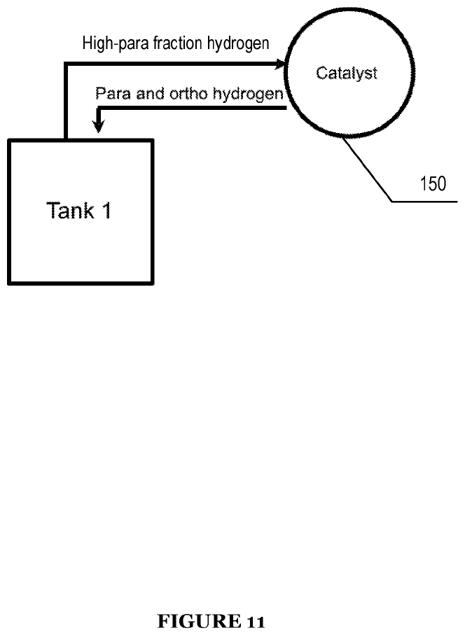

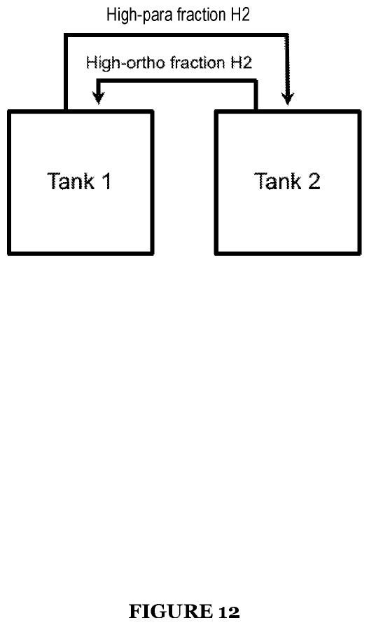

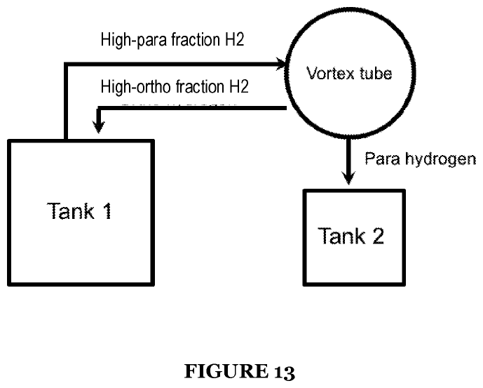

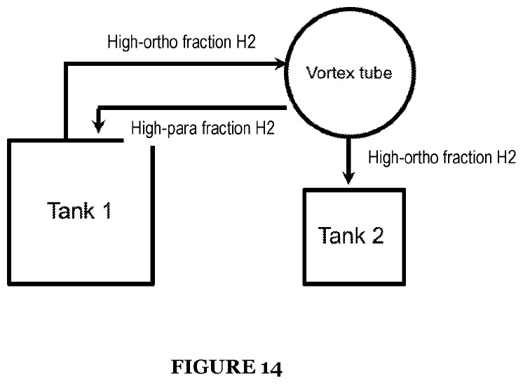

In one example, as shown in FIG. 7, the inner liner 3 may have a relatively cylindrical inner section with isotensoid shaped ends, or dome-shaped ends, or relatively hemispherical ends on the top and bottom of the cylindrical inner section. In some variations, the shape of the end caps may be optimized to further increase volume-to-surface area of the inner storage volume. This process can occur through spin-forming techniques, hot-forming techniques, or by welding end-caps to the cylindrical section. For variations that comprise a set of storage vessels, as shown in FIG. 8, the relatively cylindrical geometry may enable organized stacking of the vessels. In another example, the inner liner 112 may be relatively spherical. Spherical liners 112 may maximize the volume to surface area ratio. For variations that comprise a set of inner pressure vessels 110, spherical inner pressure vessels may be organized in a pod-like fashion as shown in FIG. 9. Various stacking arrangements may be used to optimize space usage. As shown in FIG. 10, for a fixed volume of hydrogen, by increasing the volume to surface area ratio, the dormancy for a fixed volume of hydrogen increases due to the “dip” in pressure caused by the para-to-ortho conversion of hydrogen. Generally, the geometry of the inner pressure vessel 110 may be chosen such that the volume to surface area ratio may be any value of approximately in the shaded region, or to the right of the shaded region of FIG. 5; to a maximum of a spherical shape. To summarize, in many variations, the shape of the inner vessel 110 (and thus the surface area to volume ratio) may be chosen dependent on the use case, potentially in conjunction with catalytical activity that will be discussed further down.

The system may include an insulation layer 120. The insulation layer may include insulating material 5. The insulation layer 120 functions to provide insulation between the inner pressure vessel 110 from the external environment. The insulation layer 120 may surround the inner pressure vessel 110 and be situated between the outer wall 130 and the inner pressure vessel.

The insulation layer 120 may include an insulating material 5, such as multi-layer insulation, metal foil, perlite, silica microspheres or fibers, or polymeric foam. The insulating material 5 functions to provide the material insulation for the storage vessel. The insulation material 5 may be optimized to minimize heat entrance to a level such that natural para-ortho conversion can occur before venting happens. The composition of the insulating material 5 may include any type of material that provides insulation. The material in the insulation layer 120, may be layered thus providing further insulation by a gaseous or material boundary between each material type and/or layer. Examples of materials that can make up the insulating layer 120: include foil, fiberglass, and foam. In one example, the insulating material 5 comprises a layer of foam.

The insulating layer 120 may further include gaseous insulation. In many variations, the insulating layer 120 may be maintained in a high vacuum to prevent convection. In another variation, an insulating gas may be pumped into the insulating material 5 (e.g., air, argon) to provide insulation. In some variations, the insulation material 5 may comprise a multi-layer insulation (MLI), for example ten or twenty sheets of paper and foil, under high vacuum (<1 μbar). In some examples, soft vacuum may also be adequate.

The storage vessel may include an outer wall 130. The outer wall 130 functions as the external shell of the storage vessel providing an enclosure for the insulating layer 120. In many variations, the outer wall 130 may comprise an outer jacket 8 composed of metal, such as aluminum alloys or stainless-steel alloys.

Although in this application the outer wall 130 is shown to have relatively the same geometry as the interior containers, though the outer wall 130 may have geometries differing from the interior containers. The outer wall 130 may have any desired external geometry. In one variation, the outer wall 130 has a relatively cylindrical geometry to match the interior and save cost on material. In one example of this variation, the outer wall is composed 130 of stainless steel (e.g., with wall thickness of 2 mm or less), relatively cylindrical, with relatively hemispherical domes welded onto each end of the outer wall. In another variation, the outer wall 130 has a rectangular solid shape with square ends, thereby enabling easier stacking of each vessel. In another variation, the outer wall 130 may have a regular hexagonal solid shape. The hexagonal shape may enable easy stacking of the storage vessel, while somewhat maintaining the cylindrical shape of the interior. The outer wall 130 may additionally aid in insulation. In one example, the outer jacket 8 may contain insulating materials, including a coating of a low-emissivity material.

The system may include a support system 140. The support system 140 functions to generally provide structural support to the storage vessel. More specifically the support system 140 may protect the inner pressure vessel 110 and provide structural support to maintain higher pressures within the inner pressure vessel. The support system 140 may include a composite overwrap 4 and a support structure 7.

The support system 140 may include a composite overwrap 4. The composite overwrap 4 functions as the major support against the high pressure within the storage vessel (e.g., cryo-compressed hydrogen). Generally, the composite overwrap 4 is situated along and outside the inner liner 3, providing “support” to the inner pressure vessel 110. The composite overwrap 4 may be composed of material with high tensile strength. In one variation, the composite overwrap 4 is composed of a carbon fiber material embedded in a polymeric matrix such as epoxy. In some examples, the carbon fiber material includes epoxide. Additionally, in some implementations, the composite overwrap 4 may comprise a carbon fiber and epoxy hollow shell surrounding the inner liner 110.

As per the inner pressure vessel 110 and the inner liner 3, the composite overwrap may have a geometry that promotes para-ortho conversion. In variations where the composite overwrap 4 forms a shell on the outside of the inner liner 3, the composite overwrap may have a relatively similar shape to the inner lining. Alternatively, for a composite overwrap 4 outside of the inner liner 3, the composite overwrap may have a distinct shape. In one example, wherein composite overwrap 4 comprises a carbon fiber-epoxide matrix surrounding the inner liner 3, the interior side of the composite overwrap shell may have the same geometry of the inner liner, but the exterior side may have a distinct structure, to enable better stacking and positioning of multiple storage vessels. In one example, the composite overwrap 4 may contain insulating materials, including a coating of a low-emissivity material.

The support system 140 may also include one or more support structures 7. A support structure 7 functions to physically separate the outer wall 130 of the storage vessel from the inner pressure vessel 110 and provide general support to the storage vessel. In many variations, this includes enabling the support structure 7 to prevent the inner pressure vessel 110 from rotating and/or vibrating within the storage vessel body. Additionally, or alternatively, the support structure 7 may enable inner pressure vessel 110 to breathe (i.e., pressure/depressurize) as necessary for function of the storage vessel.

The support structure 7 may be situated between the inner pressure vessel 110 and the outer wall 130, wherein parts of the support structure 7 are physically adjacent to both structures (e.g., to provide structural support). Dependent on implementation, the support structure 7 may, or may not, pass through insulating layer 120. In many variations, the support structure 7 may include support rings situated concentrically around the inner pressure vessel 110 with attachments from the concentric rings connecting inwards to the inner pressure vessel 110 and outwards to the outer wall 130. The support structures may be made of structural-thermal materials, such as G-10, Teflon, Rohacell, and Balsa Wood.

In many variations, as shown in FIGS. 11-15, the system may further include a catalyst, and/or a catalyzing system 150. The catalyzing system 150 may function to speed up the para to ortho conversion. Additionally or alternatively, the catalyzing system 150 may function to promote and/or control para-to-ortho conversion. The catalyzing system 150 may include a catalyst and a means of incorporating the catalyst with the cryo-compressed hydrogen, e.g., pumps, valves, etc. As a major use case of the system is to improve the dormancy of stored cryo-compressed hydrogen thereby reducing the necessity for hydrogen venting, activating the para to ortho conversion of hydrogen at the correct time may play a useful role in increasing dormancy. Dependent on the desired use case the catalyzing system 150 may have many different levels of utilization and may be implemented multiple ways into the system.

In one variation, as shown in FIG. 11, the catalyzing system 150 may be a distinct body (e.g., tank) from the hydrogen storage vessel. The catalyzing system 150 may be connected to the tank via a connected inlet channel and outlet channel. Para hydrogen is pumped through the inlet channel and passed through the catalyst system 150 to promote para-to-ortho conversion and then resulting para and ortho hydrogen is pumped back into the original storage vessel through an outlet channel. The catalyzing system 150 can include a catalyst material that accelerates the para-to-ortho conversion. Cycling of hydrogen to the catalyst system 150 may be controlled via a control system such that the hydrogen is dynamically pumped based on state of the storage vessel and/or desired usage.

In another variation, a catalyst is incorporated within the inner pressure vessel 110. In another variation, a catalyst may be pumped into the inner pressure vessel or otherwise introduced at the desired time to start catalyzation.

The catalyst may comprise any compound and/or material that promotes para-to-ortho conversion of hydrogen. Examples of catalysts for para-ortho conversion may include: an autocatalyst (e.g., ortho hydrogen has autocatalytic properties), molecular and material catalysts (e.g., hydrous ferric oxide, chromium oxides, nickel oxides), and/or field catalysts (e.g., paramagnets). Any other para-ortho catalysts may be incorporated as applicable. The catalyst may be a material element that could be integrated into the surface of the inner liner 3 or other tank structure (if the catalyst is introduced through a separate catalyzing system external to the storage vessel). The catalyst may be designed in such a way such that it does not also function as a hydrogen storage adsorbent. That is, the catalyst will have a minimum contribution to the storage capacity of the overall system. Such a design requirement avoids the thermal management complexity that arises from adsorption and desorption events. Furthermore, given the exceptionally high densities of cryo-compressed hydrogen, an adsorbent would likely decrease the storage capacity. In one implementation of this example, the catalyst may be implemented as a non-porous thinly coated sheet onto the surface of the inner liner 3 (or other tank structure). The catalyst would thus have a “minimal” surface area to function as an adsorbent.

The catalyst may be incorporated within the storage vessel, or as a distinct unit. As part of the storage vessel, molecular or material catalysts may be incorporated on, within, or adjacent to the inner pressure vessel 110. In one variation, catalyzing system 150 may include a back plug that contains a solenoid valve within the inner pressure vessel 110, wherein, the solenoid valve may be opened to expose the interior contents of the storage vessel to the catalyst. In another variation, the catalyst may be lined within the inner liner 3. A magnetic field (e.g., by a paramagnet), may be used to activate/deactivate (or increase) the catalyst activity.

Additionally or alternatively, the catalyst may be incorporated in a distinct unit (e.g., a separate storage vessel), wherein the catalyzing system 150 may pump or store cryo-compressed hydrogen within the distinct unit to enable para to ortho catalysis.

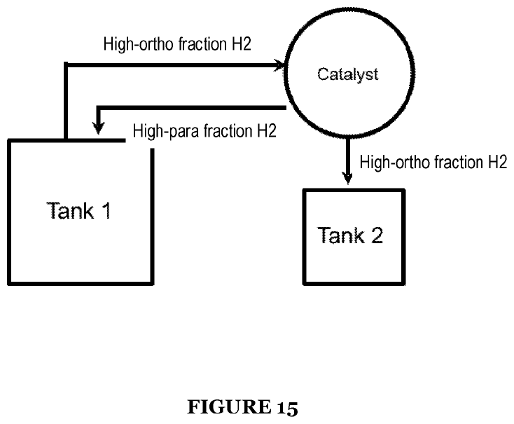

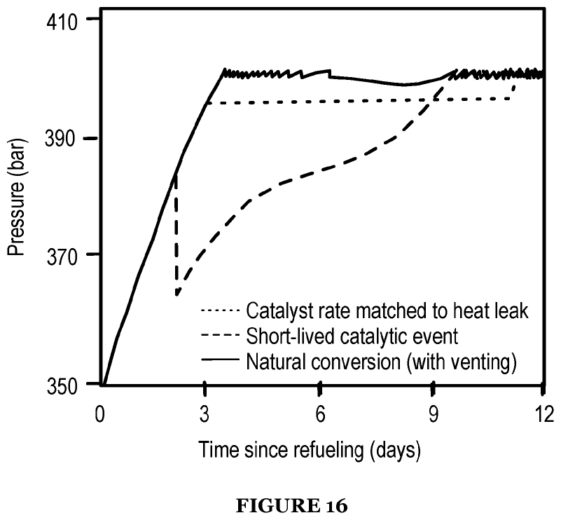

As shown in FIG. 16, the catalyst activity (active or inactive) and rate can be tuned to optimize dormancy. In one example, the catalyst rate can be tuned so that the induced endothermicity matches the heat leak into the system, so that the apparent heat transfer is zero, and thereby the bulk hydrogen pressure remains constant, maximizing dormancy as reflected in the line in FIG. 16 where the catalyst rate is matched to heat leakage from the system. In another example, reflected by the plot of the short-lived catalytic event, a catalyst may be used to reduce pressure.

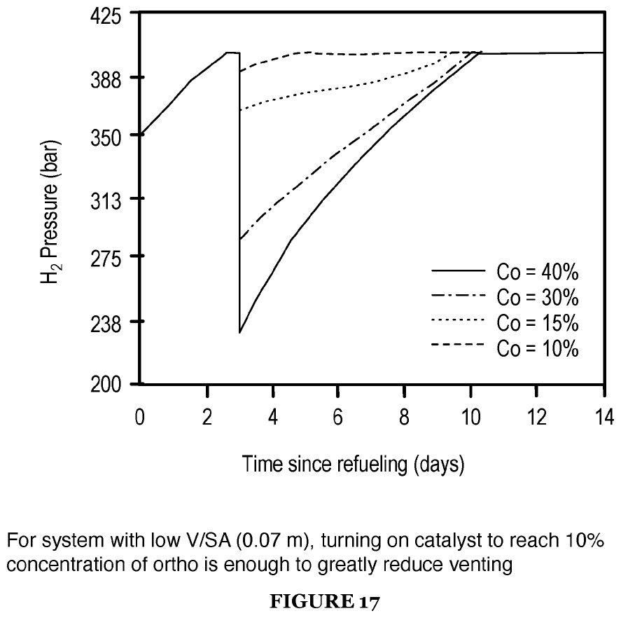

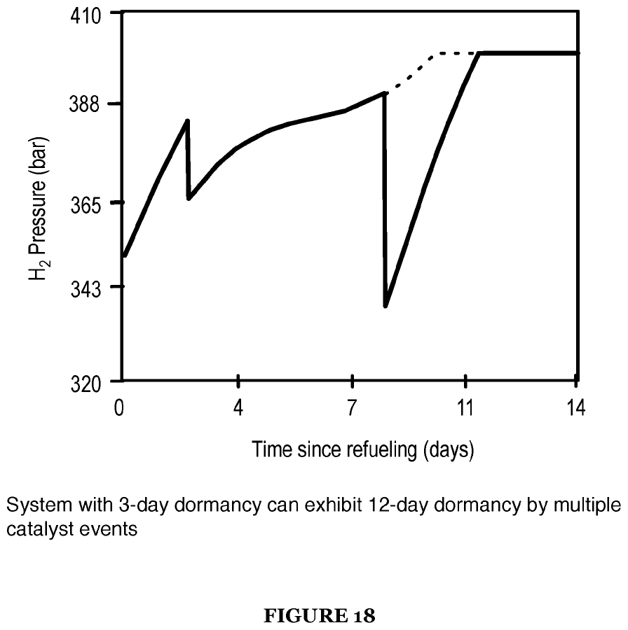

Dependent on implementation, catalytic activity via the catalyzing system 150, may be employed continuously, or employed for some interval. These intervals may be based on a period of time, based on the composition the cryo-compressed hydrogen, other thermodynamic factor (e.g., internal pressure of the storage vessel, internal temperature of the storage vessel), or hydrogen usage (e.g., activating catalyzation if it is known that cryo-compressed hydrogen will not be used up in the near future). As shown in FIG. 17, activation of a catalyst may cause a drop in pressure thereby increasing dormancy. In one example, turning on the catalyst to reach just 10% of an ortho concentration has an outsized impact on dormancy. Additionally, as shown in FIG. 18, multiple catalytic activations (i.e., activation of catalyst on day 2 and day 8) may be used to further increase hydrogen dormancy. Analogous to how a catalyst may be added/activated, a catalyst in some variations the catalyst may be removed/deactivated, effectively slowing down the para to ortho reaction rate. Thus to summarize, catalyst activity may be used to speed up, or slow down the para to ortho reaction. This may be done in a continuous or interval fashion, wherein multiple intervals may be incorporated as desired.

Dependent on implementation, the catalyzing system 150 may include a catalyst, and/or may enable the addition or removal of a catalyst or catalyst activity. FIGS. 11-13 show example system configurations that activate and/or increase catalyst activity, and FIGS. 14-15 show example system configurations that deactivate, and/or decrease catalyst activity. For example, as shown in FIG. 11, the catalyst also be placed as an exterior system to a storage vessel. In this example, the storage vessel labeled tank 1 may primarily contains para hydrogen (e.g., the tank has just recently been filled with para cryo-compressed hydrogen) at some point. Some of the para hydrogen may exit the tank through a connected channel, enter a catalyst bed or chamber, and circulate back as a mixture of ortho and para hydrogen. A catalyst may be integrated into the catalyst bed to induce para-to-ortho conversion to increase the percentage to para hydrogen. As the concentration of ortho hydrogen increases in the tank, the bulk para to ortho conversion increases due to autocatalysis (i.e., ortho hydrogen functions as the catalyst).

In variations where the catalyst includes an auto-catalyst (i.e., ortho hydrogen), the auto-catalytic properties of ortho hydrogen may be controlled to catalyze para to ortho conversion. To modify catalytic activity, ortho hydrogen may be added, removed, or isolated (e.g., by using an adsorbent); to allow/prevent, or improve/worsen ortho auto-catalysis. In some variations, ortho hydrogen, or an ortho hydrogen mixture with increased ortho hydrogen, is isolated (e.g., by implementation of a magnetic field). In some variations, ortho hydrogen may be localized to a specific region of the inner pressure vessel 110, or localized to a separate storage vessel (e.g., a storage vessel for just ortho hydrogen, or primarily an ortho hydrogen mixture, such as room-temperature hydrogen, which contains 75% ortho hydrogen. The active concentration of ortho, or the exposure of ortho molecules to para molecules, increases, and thereby speeds up the conversion rate.

In one example, the catalyzing system 150 may include an adsorbent. The adsorbent may function to preferentially adsorb the ortho hydrogen, thereby localizing the catalyst. In one example, the adsorbent may be situated in the inner liner 3 thereby enabling localization of ortho hydrogen to the interior surface of the inner lining.

In another auto-catalyst example, the catalyzing system 150 may include an exterior vortex tube connected to the inner pressure vessel 110. Contents of each inner pressure vessel 110 may be pumped through the vortex tube, wherein ortho hydrogen may be separated using temperature. The hydrogen from the storage vessel flows into the inlet of such a vortex tube. Within the tube, the warmer molecules will preferentially be in the ortho state. These will be flowing on the exterior of the tube, and eventually out through slits. The colder, ortho hydrogen will continue to flow through the interior and ultimately be stored separately (e.g., in an additional storage vessel). In variation shown in FIG. 13, para hydrogen from tank 1 may be cycled into the vortex tube, which then output ortho hydrogen back to tank 1 and para hydrogen to tank 2. In a variation shown in FIG. 14, ortho hydrogen from tank 1 may be cycled into the vortex tube, which then outputs para hydrogen to tank 1 and ortho hydrogen to tank 2. In one implementation, the vortex tube is lined up with an ortho-para catalyst, such as a non-porous metal oxide. This configuration may enable the para to ortho conversion to occur in tandem with separation of the ortho from the para molecules, as depicted in FIG. 13 and FIG. 14.

In another variation, an external catalyzing system may take in one form of hydrogen, and then redeliver para hydrogen and ortho hydrogen to different storage vessels. As shown in FIG. 15, ortho hydrogen may be supplied from tank 1 to the catalyzing system, and then para hydrogen may be dispensed back to tank 1 and ortho hydrogen dispensed to a second storage vessel tank 2.

In one example that includes a catalyzing system 150 for a multi tank system, a storage vessel may contain approximately 95% para hydrogen. The catalyzing system 150 may pump the para hydrogen from the tank and into the vessel that contains the catalyst. After the hydrogen leaves the catalyst, the composition can be around 60% para hydrogen and 40% ortho hydrogen.

In another example, as shown in FIG. 12, a high-ortho fraction hydrogen is used as an autocatalyst. High-ortho fraction hydrogen may be pumped into an inner pressure vessel 110, thereby accelerating autocatalysis of para to ortho hydrogen in that tank. This example may also be implemented in a multiple storage vessel system. In one implementation, one of the storage vessels may be purposefully designated to have “inferior” insulation. In other words, one or more vessels may be a low insulation vessel and one or more vessel with high insulation vessel. The low insulation vessel can be characterized by thermal insulation properties allowing greater thermal transfer between the inside and outside of the vessel compared to the high insulation vessel. For example, the low insulation vessel could be constructed without an insulation layer, have a lower performance insulation, and/or positioned on the outside of a storage vessel array such that this lesser insulated storage vessel receives more heat as compared to other storage vessels. In the example configuration of FIG. 12, tank 2 could be a low insulation storage vessel and tank 2 could be a high insulation storage vessel. Additionally, in some implementations, this storage vessel may be rated for higher pressure as compared to the other storage vessels and isolated from them (e.g., it may be valved off). Hydrogen contained in this low insulation storage vessel may then heat up more rapidly than the other storage vessels, and para-ortho conversion in this vessel would proceed faster than in the other vessels. Since this storage vessel is valved off and warmer, its pressure would be higher than within other storage vessels. When needed, such as when pressure approaches the venting pressure, the valved off storage vessel may be opened, thereby introducing hydrogen with high ortho fraction into the remaining storage vessels, promoting para-ortho conversion.

In another example comprising multiple storage vessels, one of the storage vessels may contain a para-ortho catalyst within the interior volume. Due to the enhanced para-ortho conversion, this tank will have a higher fraction of ortho hydrogen than the other tanks. This hydrogen may then be introduced into the other hydrogen tanks (e.g., by a pump mechanism. Accordingly, in some variations a subset of a set of storage vessels may include catalyst system (internal or external), and a second subset of the set of storage vessels may not include a catalyst system (at least not directly). Hydrogen could be cycled between the subsets of storage vessels to manage ortho-para hydrogen concentrations.

In another example for multiple storage vessels, one of the storage vessels may be a catalyst-filled storage vessel that is situated near the top of an array of storage vessels. Additionally, in some implementations, this storage vessel may be colder than the other storage vessels due to enhanced para-ortho conversion from the catalyst. If the pressure in this storage vessel is maintained to be equal to the other storage vessels, its density will be higher. Therefore, opening a valve on this storage vessel will introduce natural circulation of hydrogen, as higher density hydrogen will tend to flow down to the lower pressured storage vessels. This will introduce ortho-H2 to the other vessels, catalyzing conversion.

The catalyzing system 150 may be implemented in conjunction with the inner pressure vessel 110 geometry. That is, a para to ortho catalyst may be beneficial to further extend dormancy in storage with high volume to surface areas, such as 0.11 or greater.

As shown in FIG. 10, where the venting pressure is shown as the black bar at approximately 400 bar, controlling the timing and the rate of the para-ortho conversion (i.e., the dip in each curve) may further increase dormancy prior to the need for venting. For some tanks, or vessels, with volume to surface area ratio below a certain ratio venting may occur earlier (e.g., less than 4 days for V/SA<0.7 m). For a volume to surface area ratio that is constrained, by incorporation of a catalyst, the para to ortho conversion may be accelerated, thereby lowering the pressure of the stored hydrogen to delay venting. For this reason, the implementation of catalyst control may have a significant impact on dormancy.

In one example for a multiple tank system, the system may contain primarily para hydrogen with a given set of tank geometries (i.e., volume to surface area ratios for each tank). In this example, it is anticipated that the storage vessels will vent under normal conditions. Some percentage of the hydrogen may be removed and exchanged for ortho hydrogen from a separate tank which contains primarily ortho hydrogen. In other words, a fluidic exchange between the tank containing mostly para hydrogen and the tank containing mostly ortho hydrogen may occur. In such an example, the rate of conversion is increased in the tank that contained initially primarily para hydrogen. This operation may be desirable for systems that do not have a sufficiently high volume to surface area ratio and where venting is expected to occur. In such an instance, a sufficient amount of ortho hydrogen may be introduced into the tank such that the rate of para-ortho outpaces the rate of natural pressurization from heat leak into the tank, and venting is avoided.

In many variations, the system may include a control system. The control system may function to manage different operational options of the system. The control system may control venting, dispensing, activation/deactivation of a catalyst, cycling of hydrogen between subsets of storage vessels.

The system may include pressure and/or temperature sensors that collect pressure and/or temperature sensors. This may be used to monitor state of hydrogen fuel. Concentrations of para hydrogen and ortho hydrogen may be monitored and/or predicted from such sensor data and used to control one of venting, use of a catalyst system, and/or cycling of hydrogen between storage vessels. Dispensing may also be used to alter management of fuel in the storage vessel. In one variation, the storage vessel may include static or controllable storage configuration parameters that are used to alter management of the storage vessels by the control system. In one example, a dormancy target may be configured to determine a target amount of dormancy. The para to ortho conversion can be managed through venting, use of a catalyst system, adjusting thermal conditions to target the dormancy configuration.

### 3. Method

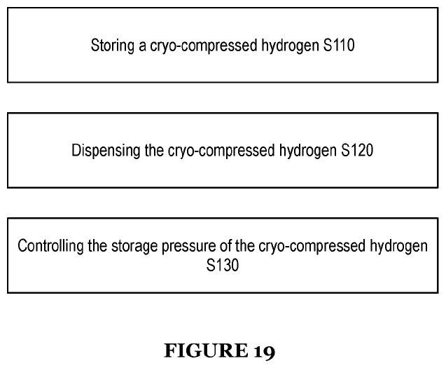

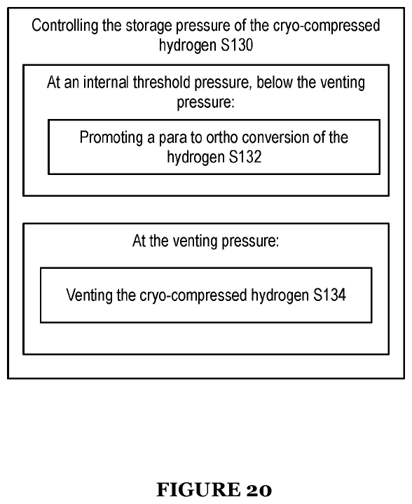

As shown in FIG. 19, an operating method for cryo-compressed hydrogen storage tanks includes: storing a cryo-compressed hydrogen S110; dispensing the cryo-compressed hydrogen S120; and controlling the storage pressure of the cryo-compressed hydrogen S130. Controlling the storage pressure of the cryo-compressed hydrogen S130 may further include: at an internal threshold pressure below a venting pressure, promoting a para to ortho conversion of the cryo-compressed hydrogen S132; and at the venting pressure, venting the cryo-compressed-hydrogen S134. The method functions to enable extended storage and use of cryo-compressed hydrogen by leveraging the endothermic para to ortho configuration change of cryo-compressed hydrogen molecules. That is, as cryogenically stored hydrogen begins increasing in pressure due to heat leaking in from the warmer exterior environment, the method may control/induce an endothermic change in molecular hydrogen, which decreases the pressure of bulk hydrogen in the system and extends dormancy, i.e., extends the time that the hydrogen can be stored prior to the need to vent hydrogens.

The method may be incorporated with the system described above but may be generally incorporated with any applicable system for cryogenically stored hydrogen. The method may be particularly suited for a series of cryo-compressed hydrogen storage tanks, wherein catalyst compounds (e.g., the autocatalyst ortho-hydrogen) and the different configurations of hydrogen (i.e., para and ortho) may be isolated and transferred between storage tanks.

Block S110, which includes storing a cryo-compressed hydrogen S110, functions to store hydrogen in a desired thermodynamic state (e.g., low temperature, moderate pressure), in the appropriate storage vessel. In particular, S110 includes storing, in a cryo-compressed hydrogen storage vessel, cryo-compressed hydrogen. This may comprise obtaining (e.g., fueling up with) hydrogen that enters in its cryo-compressed state, or fueling up with liquid hydrogen, and letting the system pressurize overtime (i.e., thermal compression), reaching the cryo-compressed state inside the tank. Any general commercial, or specialized, means for pressurizing and/or cooling hydrogen may be implemented.

Storing a cryo-compressed hydrogen S110 may include filling a storage vessel enabled to store the moderate to high pressure, low temperature hydrogen. In many variations, cooling and pressurizing may happen in conjunction with filling the storage vessel (e.g., hydrogen may be pressurized by the process of filling the storage vessel). In some variations, the filling a storage vessel may comprise filling a storage vessel that has a geometry that enables the para to ortho conversion of hydrogen molecules to occur before sufficient heat leak into the system has occurred.

In many variations, block S110 may comprise storing the cryo-compressed hydrogen in storage vessel(s) with a volume to surface area ratio above a certain threshold. For example, the volume to surface area ratio for the storage vessel may be chosen using design parameters for desired performance such as indicated in FIG. 5 and/or FIG. 6, based on the required quantity of cryo-compressed hydrogen needed; wherein, the applicable thermodynamic conditions and storage vessel size and quality are used to determine the dormancy time (and venting pressure), wherein the volume to surface area ratio may be taken into account as shown in FIG. 10.

Block S120, which includes dispensing the cryo-compressed hydrogen, functions to dispense hydrogen as a fuel source for use. Dispensing the cryo-compressed hydrogen S120 may be dependent on the use case (e.g., truck, datacenter) and the amount of fuel need (e.g., distance driving, amount of data-center activity during peak hours, etc.). In many variations, wherein the storage tanks are directly connected as a fuel source (e.g., as a gas tank). Dispensing the cryo-compressed hydrogen S120 may happen in real time as the machinery functions. Dispensing cryo-compressed hydrogen may result in thereby reducing the internal pressure of the cryo-compressed hydrogen vessel. In some cases, dispensing may impact or alter the controlling the storage pressure of the cryo-compressed hydrogen.

Block S130, which includes controlling the storage pressure of the cryo-compressed hydrogen, functions to monitor and maintain the hydrogen pressure as required (i.e., controls hydrogen dormancy). That is, block S130 functions to maintain the hydrogen pressure at, or below, the venting pressure of the storage vessel. In this manner, controlling the storage pressure of the cryo-compressed hydrogen may include: promoting a para to ortho conversion of the cryo-compressed hydrogen S132, and venting the cryo-compressed hydrogen S134. Dependent on implementation, block S130 may include additional ways of modifying the hydrogen pressure. As block S130 is in response to increasing hydrogen pressure, if the hydrogen pressure is maintained in other ways (e.g., a small amount of hydrogen was initially stored, or a significant amount of hydrogen is dispensed), it may not be necessary to actively control the storage pressure of hydrogen.

Block S132, which includes promoting a para to ortho conversion of hydrogen, functions to reduce the hydrogen pressure, thereby increasing the dormancy of the stored hydrogen. That is block S132, may induce the para to ortho conversion of hydrogen and/or increase the reaction rate of the para to ortho reaction. As this is an endothermic reaction, the dormancy of the stored hydrogen may be increased in this manner. Promoting a para to ortho conversion of hydrogen S132 may be incorporated passively (e.g., naturally via ortho hydrogen autocatalysis) or actively (e.g., by use of a catalyst). That is the para to ortho conversion may be passively promoted as part of storing a cryo-compressed hydrogen S110 (e.g., by enabling the para-ortho conversion to effectively occur before venting, through the storage vessel geometry as described above), or may occur actively (e.g., by addition or activation of a catalyst).

Promoting a para to ortho conversion of hydrogen S132 preferably occurs at some threshold pressure below the venting pressure. This threshold pressure may be set in advance and can be dependent on how much hydrogen is dispensed (S120), and/or how much hydrogen is expected to be dispensed. That is, the threshold pressure is chosen such that promoting a para to ortho conversion of hydrogen S132 will sufficiently lower the internal hydrogen pressure to “significantly” increase the hydrogen dormancy.

The promoting a para to ortho conversion of hydrogen S132 may be implemented at any time. In some variations, promoting a para to ortho conversion of hydrogen S132 occurs at a threshold internal pressure which is below the venting pressure for the utilized storage vessel, so that the endothermicity decreases the pressure and venting is avoided. As shown in FIG. 10, where the straight bar represents the venting pressure and the curve drops are due to the para to ortho conversion of hydrogen, the threshold internal pressure is chosen such that inducing the para to ortho conversion sufficiently decreases the internal H₂ pressure to significantly increase the time prior to reaching the venting pressure. For example, as shown for middle curve in FIG. 10, promoting a para to ortho conversion of hydrogen S132 may increase the dormancy from approximately three days to approximately fifteen days. In some instances, the venting pressure may be increased, or the tank geometry may be optimized, or both, in order to reach the targeted dormancy for the end-use application.

In some variations, promoting a para to ortho conversion of hydrogen S132 may include actively inducing the para to ortho conversion. In some examples, this may comprise adding, or exposing, the cryo-compressed hydrogen to a catalyst.

In some variations promoting a para to ortho conversion may be performed continuously for continuous catalyst operation. Continuous catalyst operation may be used if, for example, a catalyst is integrated into the static design of a storage vessel. In other variations, promoting a para to ortho conversion may be performed through one or a plurality of catalyst activation events. For example, a catalyst may be periodically exposed to a hydrogen-based pressure state of the hydrogen in a storage vessel.

As shown in FIG. 17, activation of a rapid ortho catalyst to convert even a small percentage of the para hydrogen to ortho hydrogen gives rise to endothermicity that greatly reduces the bulk pressure of the stored hydrogen, thereby increase dormancy. Adding ortho hydrogen (i.e., an auto-catalyst), or a catalyst, or exposing the stored hydrogen to ortho hydrogen or to a catalyst, may induce the para to ortho conversion, thereby decreasing internal pressure within the storage vessel. Dependent on implementation, any catalyst that catalyzes the para to ortho state change of hydrogen may be implemented. Examples of catalysts that may be added include: hydrous ferric oxide, chromium oxides, nickel oxides, and ortho hydrogen. The catalyst may be porous, or it may be non-porous catalyst. For example, the catalyst may be solid magnetic metal layer deposited on a surface that can be exposed to the hydrogen; thus, promoting a para to ortho conversion of the hydrogen S132 may comprise pumping the cryo-compressed hydrogen along the deposited catalyst metal layer. Dependent on the implemented catalyst, block S132 may include adding the catalyst, mixing the catalyst, and/or otherwise activating the catalyst. Adding the catalyst may comprise adding a molecular catalyst, material catalyst, and/or activating the (e.g., magnetic) field catalyst to catalyze para to ortho conversion (e.g., adding a nickel oxide). Mixing the catalyst may comprise combining an already present catalyst. For example, the auto-catalyst, ortho hydrogen, may be generally isolated or localized from para hydrogen, and catalytic activity may be induced by mixing with the para hydrogen. Activating the catalyst may include adding reagents, turning on a valve to expose the catalyst, and/or fields that start, or enhance, catalytic activity of the catalyst. For example, a magnetic field may be used to induce the hyperfine interaction between a metal's electron spin and the proton spin in the hydrogen molecules.

Dependent on implementation, any and/or all types of applicable catalysts may be used. As shown as FIG. 11, a tank with primarily para hydrogen may be connected to a catalyst. The para hydrogen may be shuttled from the tank, transferred through the para-to-ortho catalyst, and shuttled back to the tank. Having gone through the endothermic conversion, the hydrogen will cool the system as it re-enters the tank. Furthermore, it will accelerate the auto-catalytic process. In one example, an external catalyst is implemented to initiate, or kick start, the conversion process, until there is a critical concentration of ortho hydrogen in the storage tank, so that the autocatalysis is sufficient to ultimately decrease the bulk pressure of the stored hydrogen, preventing venting. In some variations, as shown in FIG. 12, there can exist a dedicated tank that stores a high fraction of ortho hydrogen. This high ortho fraction hydrogen can be introduced into other storage vessels which are primarily para hydrogen, thereby inducing the auto catalytic conversion.

As discussed, a system may include different catalyst system variations which may lead to different detailed processes for inducing or promoting para-to-ortho conversion.

In one variation, the system includes an internal catalyst system, accordingly, inducing or promoting the para to ortho conversion can include applying a catalyst within a storage vessel storing the cryo-compressed hydrogen.

In some variations, applying a catalyst within the storage vessel may use an internal static catalyst, wherein the method includes supplying a storage vessel with a catalyst integrated into a chamber where the cryo-compressed hydrogen is stored.

In some variations, applying a catalyst within the storage vessel may include one or more of: dispensing a catalytic material into stored hydrogen, inserting a catalyst material, actuating a mechanism to expose a catalyst material, activating an electromagnet, and/or performing other actions to dynamically apply a catalyst. These variations function to trigger exposure of the cryo-compressed hydrogen to a catalyst material into the chamber based on when a catalyzed conversion is desired. In some variations, the amount of catalytic material exposed may be exposed to offer a variable amount of the catalytic-accelerated conversion.

In one such variation, a continuous or discrete catalyst activation event may include speeding up or accelerating up conversion by pumping ortho hydrogen into the storage vessel. Catalysts may also be used for slowing down conversion. For example, a continuous or discrete catalyst activation event may be used to slow down conversion. In one variation this may include slowing down or deaccelerating conversion by isolating ortho hydrogen. This may be achieved by separating the ortho hydrogen from the para hydrogen and flowing the ortho hydrogen (or high concentration ortho hydrogen) to a different storage vessel. The separation can occur by exploiting the difference in adsorption energy between the two nuclear isomers, as flowing the hydrogen through an adsorbent, or by exploiting their differing temperatures and separating using a vortex tube.

In other variations, the system includes an external catalyst system, and accordingly inducing or promoting the para to ortho conversion includes cycling the cryo-compressed hydrogen to the external catalyst system, triggering para-to-ortho conversion within the external catalyst system and cycling at least a portion of the cryo-compressed hydrogen that underwent the para-to-ortho conversion to one or more storage vessels. As shown in variations in FIG. 11, this may cycle para and ortho hydrogen back to the source storage vessel. As shown in FIGS. 13, 14, and 15, the output of the external catalyst system may be distributed to different storage vessels. This distribution may be used to control the ratio of para hydrogen and ortho hydrogen.

In a related variation where a system with multiple storage vessels, inducing or promoting the para to ortho conversion may include distributing cryo-compressed hydrogen between storage vessels based on differing concentrations of para hydrogen and ortho hydrogen. For example, a storage vessel with a surplus of ortho hydrogen may transfer surplus ortho hydrogen to a storage vessel with concentrations of para hydrogen below a threshold. Such determination of state may be sensed or measured directly, but pressure, temperature and/or other properties may be sensed and used as defining conditions for transferring hydrogen between storage vessels. Dynamically transferring cryo-compressed hydrogen to adjust balance of para hydrogen and ortho hydrogen can be used in combination with other catalyst systems. For example, an external and/or internal catalyst system may be used for a subset of storage vessels, while other storage vessels have para-to-ortho conversions managed by receiving para and/or ortho mixtures of hydrogen from other storage vessels with active catalyst systems in place.

In some variations, block S132 may include modifying the rate of the catalyst activity, thereby modifying the reaction rate for the para-ortho conversion. Although catalyst activity is generally considered to be constant (for a given temperature), modifying the reaction rate may include adding/activating an amount of catalyst below some level of saturation for that catalyst, thereby inducing the para to ortho conversion but not at the actual catalyst rate for the entire system. By functioning at a level below the level of catalyst saturation, para to ortho conversion reaction rates may be increased or decreased. In one example, the flow rate of hydrogen through the external para-to-ortho catalyst can be tuned so as to control the overall conversion rate. As shown in FIG. 17, the internal pressure may be changed with different concentrations of catalyst. Additionally or alternatively, as shown in FIG. 18, a catalyst may be activated/deactivated (added/removed) multiple times, to extend the reaction time. Through multiple activation events, dormancy may be further increased.

Block S134, which includes venting the cryo-compressed hydrogen, functions to release hydrogen thereby keeping the storage vessel stable. Venting the cryo-compressed hydrogen S134 may occur at any time prior to passing the venting pressure for the container storing the hydrogen. To minimize the necessity for venting, venting the cryo-compressed hydrogen S134 may preferably occur at, or near, the venting pressure. As the storage vessel reaches the limits of its pressure capacity, hydrogen may be released to stabilize the system. As a primary focus of the method is to prevent/reduce hydrogen venting (i.e., loss of energy), block S134 may not be included in all implementations of the method. For long term storage cases of the method, venting the cryo-compressed hydrogen S134 may be an inevitability; but for storage during sufficient use of hydrogen fuel, extending the dormancy of hydrogen until a sufficient amount of hydrogen depleted, may prevent the requirement for venting.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

Similarly, in another variation, a non-transitory computer-readable medium storing instructions that, when executed by one or more computer processors of a computing platform, cause the computing platform to perform operations of the system or method described herein such as: storing a cryo-compressed hydrogen S110; dispensing the cryo-compressed hydrogen S120; and controlling the storage pressure of the cryo-compressed hydrogen S130. Such process execution is preferably performed in connection to a cryo-compressed hydrogen storage system described herein. Any suitable variation of the system and/or method of operation may be used.

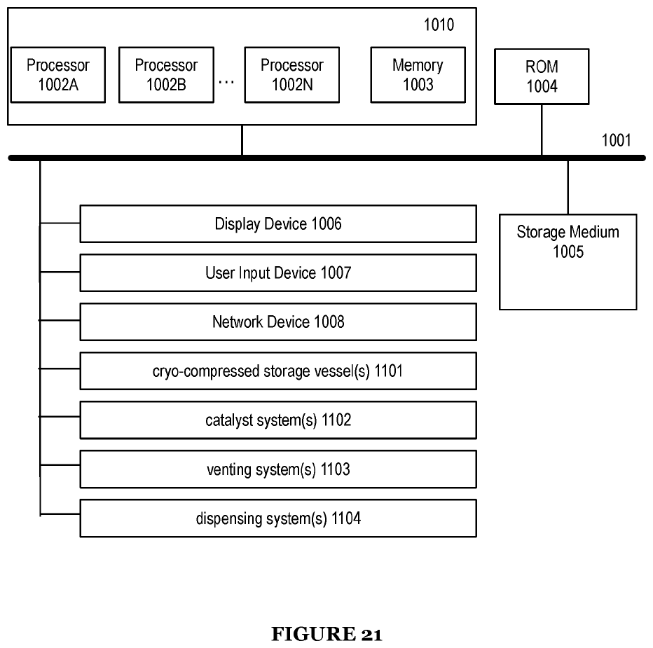

FIG. 21 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting cryo-compressed storage vessel(s) 1101, catalyst system(s) 1102, venting system(s) 1103, dispensing system(s) 1104, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1002A-1002N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A system for cryo-compressed hydrogen storage and utilization, comprising:
a set of storage vessels, wherein a subset of the set of storage vessels comprises a set of cryo-compression tanks, wherein each cryo-compression tank comprises:
an inner pressure vessel that includes an inner liner with a defined inner geometry;
an insulation layer, situated outside the inner pressure vessel;
an outer wall; and
a support structure situated between the inner pressure vessel and the outer wall;
an input valve, connected to the set of storage vessels;
an output valve, connected to the set of storage vessels, enabling gaseous dispensing from the set of cryo-compressed tanks; and
a control system, connected to the set tanks, enabling dynamic allocation and reallocation of contents, between the set of tanks.

19. The system of claim 18, wherein the defined inner geometry of the inner liner of each cryo-compression tank comprises an internal, volume to surface area, ratio within a para-to-ortho optimized range.

20. The system of claim 19, wherein the volume to surface area ratio of the inner liner geometry is 0.07 or greater.

21. The system of claim 20, wherein the volume to surface area ratio of the inner liner geometry is approximately between 0.07 and 0.11.

22. The system of claim 21, further comprising a catalyzing system that includes a catalyst, wherein activation of the catalyst enables para to ortho conversion of the hydrogen.

23. The system of claim 22, wherein the catalyst comprises ortho-hydrogen, an auto-catalyst.

24. The system of claim 23, wherein the catalyst is situated within the inner pressure of vessel of each storage vessel

25. The system of claim 24, wherein the catalyzing system further comprises an adsorbent, wherein the adsorbent isolates ortho hydrogen, thereby reducing ortho auto-catalysis.

26. The system of claim 22, wherein the catalyst is situated exterior to each storage vessel in an exterior catalyst bed, and the hydrogen from at least one storage vessel from the set of storage vessels is circulated through the catalyst bed and back to the storage vessel.

27. The system of claim 26, wherein the catalyst comprises ortho hydrogen, an auto-catalyst.

28. The system of claim 27, wherein the exterior catalyst bed comprises an additional storage vessel, and the hydrogen from each storage vessel from the set of storage vessels is pumped into the additional storage vessel, and the ortho hydrogen from the additional storage vessel is pumped into each storage vessel from the set of storage vessels.

29. The system of claim 27, wherein:
the catalyzing system further comprises an exterior vortex tube connected to the inner pressure vessel of each storage vessel from the set of storage vessels; and
wherein the contents of each inner pressure vessel is pumped through the vortex tube, thereby separating out ortho hydrogen, which is then stored separately in one storage vessel from the set of storage vessels.

30. The system of claim 26, wherein the catalyzing system further comprises an adsorbent, wherein the adsorbent isolates ortho hydrogen, thereby reducing ortho auto-catalysis.

31. A method for storing a thermodynamically dynamic cryo-compressed hydrogen comprising:
storing, in a cryo-compressed hydrogen storage vessel, cryo-compressed hydrogen;
dispensing cryo-compressed hydrogen, thereby reducing the internal pressure of the cryo-compressed hydrogen vessel; and
controlling the storage pressure of the cryo-compressed hydrogen.

32. The method of claim 31, wherein controlling the storage pressure of the cryo-compressed hydrogen further comprises:
at a threshold internal pressure, below a venting pressure, promoting a para to ortho conversion of the cryo-compressed hydrogen, thereby reducing the internal pressure of the cryo-compressed hydrogen; and
at the venting pressure, venting the cryo-compressed hydrogen, thereby reducing the internal pressure of the cryo-compressed hydrogen.

33. The method of claim 32, wherein the promoting a para to ortho conversion of the hydrogen comprises activating a catalyst.

34. The method of claim 33, wherein promoting a para to ortho conversion comprises multiple discrete catalyst activation events.

35. The method of claim 33, wherein promoting a para to ortho conversion comprises a continuous catalyst operation.

36. The method of claim 35, wherein the continuous catalyst operation may include speeding up the catalyst through pumping ortho hydrogen into the hydrogen storage vessel.

37. The method of claim 36, wherein the continuous catalyst operation may include slowing down the catalyst by isolating the ortho hydrogen.

38. The method of claim 37, wherein isolating the ortho hydrogen includes adding an adsorbent.
